(19) United States
(12) Patent Application Publication
(10) Pub. No.: US 2006/0270378 A1
(43) Pub. Date: Nov. 30, 2006

(54) Low noise block downconverter

(75) Inventors: Cheng Nan Lee, Taipei (TW); Wei Ya Liao, Taipei (TW); Chun Ching Wang, Taipei (TW)

Correspondence Address: QUINTERO LAW OFFICE, 1617 BROADWAY, 3RD FLOOR, SANTA MONICA, CA, 90404, US

(73) Assignee: WISTRON NEWEB CORP., TAIPEI HSIEN (TW)

(21) Appl. No.: 11/271,637

(22) Filed: Nov. 10, 2005

(30) Foreign Application Priority Data
May 26, 2005 (TW) TW94117217

(51) Int. Cl. H04B 1/16

(52) U.S. Cl. 455/339

(57) ABSTRACT

A low noise block downconverter. The low noise block downconverter comprises a low noise amplifier (LNA), an RF band pass filter, a mixer, a local oscillator, a harmonic filter, and a low pass filter. The low noise amplifier receives an RF input signal. The RF band pass filter is coupled to the low noise amplifier. The local oscillator provides a signal of half local oscillator 1/2 F_LO. The harmonic filter is coupled to the local oscillator and a harmonic signal of F_LO is provided to the mixer. The low pass filter is coupled to the mixer and generates an IF output signal.

### BACKGROUND

The invention relates to a low noise downconverter and, in particular, to a low noise downconverter implemented with a low frequency local oscillator.

Signals from satellites typically severely attenuate before reaching antennas. In addition, higher signal transmission frequencies over coaxial cable increases signal loss. Thus, a low noise downconverter is required to improve the higher signal transmission performance. A low noise amplifier amplifies high-frequency satellite signals by hundreds of thousand times. RF signals are then downconverted to intermediate frequency 950 MHz to 2050 MHz by circuits, such as, a mixer and a local oscillator. As a result, transmission of signals over a coaxial cable is easier and a satellite receiver can demodulate more effectively.

Satellite communication typically uses L, S, C, Ku, and Ka bands. Frequency of C band ranges from 3.7 GHz to 4.2 GHz. Frequency of Ku band ranges from 10.7 GHz to 14.5 GHz. The Ka band is defined as frequencies over 18 GHz. Development of a low noise downconverter has evolved from a lower-frequency C band to a higher-frequency Ka band. As a result, operating frequencies of main components in a low noise downconverter have become higher. A local oscillator is one of the major components in a low noise downconverter. When operating frequency thereof gets higher, the local oscillator gets more complicated, making it more difficult to control characteristic stability thereof.

FIG. 1 is a schematic diagram of a conventional low noise downconverter. An RF signal RF_A is received and amplified by a low noise amplifier 101. Noises at frequencies out of the RF band are filtered out by an RF band pass filter 103. The filtered RF signal RF_B and a signal LO_B of a local oscillator frequency F_LO are transmitted to a mixer 105. The mixer 105 generates a signal IF_A with a frequency in an intermediate frequency (IF) range. The signal IF_A is transmitted to a low pass filter 107 and noise is filtered out of the intermediate frequency range by low pass filter 107. Thus, an IF output signal IF_B is generated. In the conventional low noise downconverter, a local oscillator 109 generates a signal LO_A of local oscillator frequency F_LO and the signal LO_A is amplified by an amplifier 111. Noise therein is filtered out by a band pass filter 113 and the signal LO_B of the local oscillator frequency F_LO is obtained. It is noted that the required local oscillator frequency increases with operating frequency of the low noise downconverter. As a result, the high frequency local oscillator is sensitive to its circuit parameters as well as its manufacturing tolerance and thereof its stability is difficult to control.

### SUMMARY

An embodiment of a low noise block downconverter comprises a low noise amplifier (LNA), an RF band pass filter, a mixer, a local oscillator, a harmonic filter, and a low pass filter. The low noise amplifier receives an RF input signal. The RF band pass filter is coupled to the low noise amplifier. The local oscillator generates a signal of half of local oscillator frequency than that is required by mixer F_LO, i.e., ½ F_LO. The harmonic filter is coupled to the local oscillator and a harmonic signal of local oscillator frequency F_LO is provided to the mixer. The low pass filter is coupled to the mixer and generates an IF output signal.

The invention utilizes a lower frequency local oscillator to generate a signal with a half frequency of a required local oscillator frequency. The required local oscillator frequency is obtained by extracting a harmonic component of actual oscillator through a harmonic filter and transmitted to a mixer such that frequency downconverting is achieved.

### BRIEF DESCRIPTION OF THE DRAWINGS

FIG. 1 is a schematic diagram of a conventional low noise downconverter.

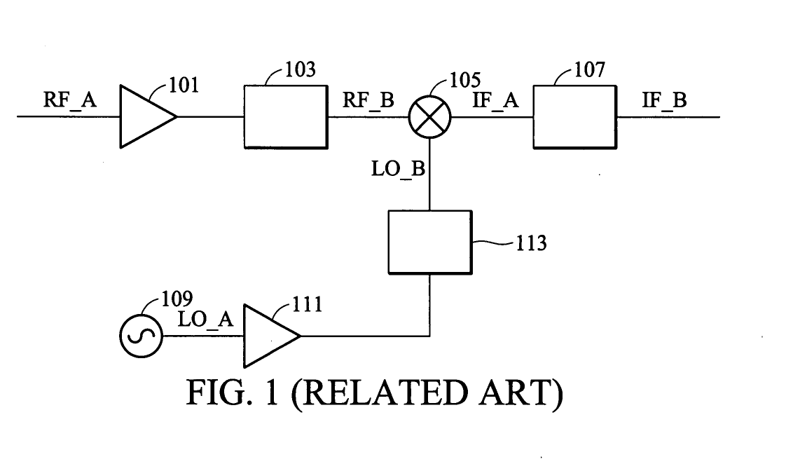

FIG. 2A is a schematic diagram of a low noise downconverter according to an embodiment of the invention.

FIG. 2B is a schematic diagram of a low noise downconverter according to another embodiment of the invention.

FIG. 2C is a schematic diagram of a low noise downconverter according to a furthermore embodiment of the invention.

### DETAILED DESCRIPTION

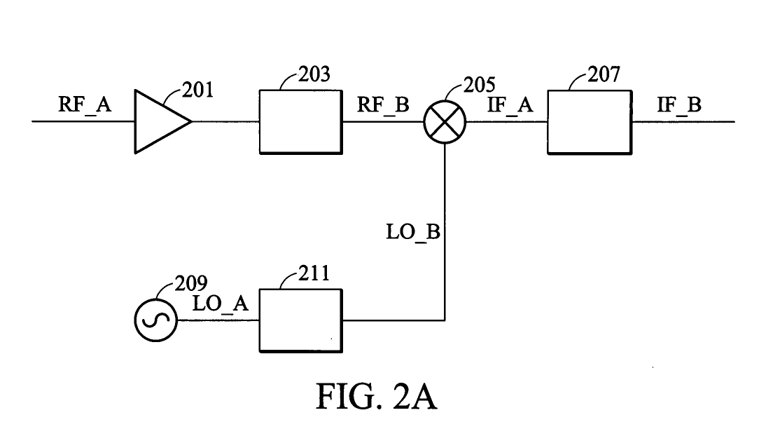

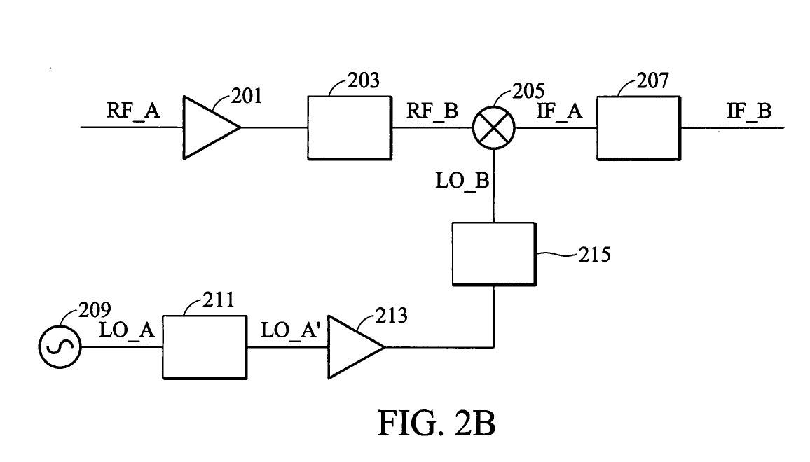

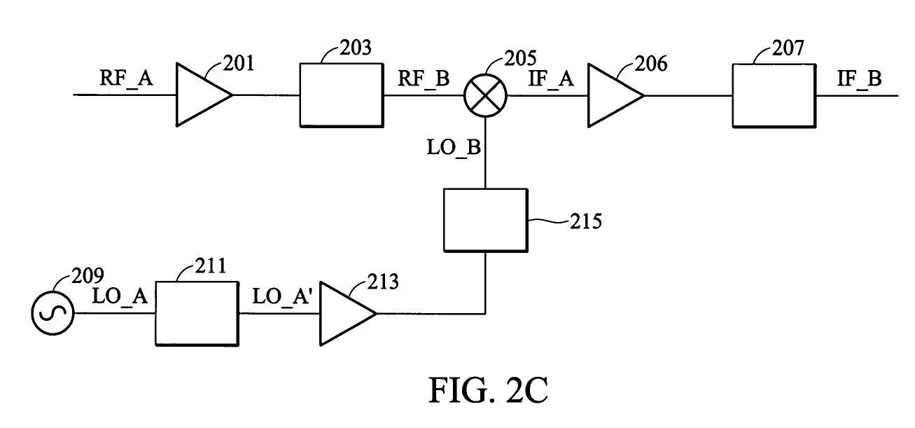

FIG. 2A is a schematic diagram of a low noise downconverter according to an embodiment of the invention. A low noise amplifier receives and amplifies an RF input signal RF_A. Noise is filtered out of an RF band by an RF band pass filter 203. The filtered RF signal RF_B and a signal LO_B of local oscillator frequency F_LO are transmitted to a mixer 205. The mixer 205 generates a signal IF_A with a frequency in an intermediate frequency (IF) range. The signal IF_A is transmitted to a low pass filter 207 and noise is filtered out of the intermediate frequency range. Thus, an IF output signal IF_B is generated. In this embodiment, a local oscillator 209 generates a signal LO_A. A dominant frequency of the signal LO_A is half local oscillator frequency (½F_LO). In the signal LO_A, there are typically harmonics of F_LO, 3/2F_LO, 2F_LO, 5/2F_LO, 3F_LO and so on other than the dominant frequency ½F_LO. The band pass filter 211 filters out harmonics of frequencies other than required local oscillator frequency F_LO such that the signal LO_B of local oscillator frequency F_LO is obtained. Preferably, the local oscillator 209 is a dielectric resonant oscillator in a typical low noise downconverter.

Moreover, the low noise downconverter can further comprise a driver amplifier 213 and a band pass filter 215, as shown in FIG. 2B, according to another embodiment of the invention. The driver amplifier 213 is coupled to the harmonic filter 211. The band pass filter 215 is coupled between the driver amplifier 213 and the mixer 205. The driver amplifier 213 amplifies a signal LO_A′ from the band pass filter 211. The band pass filter 215 filters out noise of frequencies other than the required local oscillator frequency F_LO. Thus, the signal LO_B of local oscillator frequency F_LO is generated and transmitted to a mixer 205.

Additionally, the low noise downconverter can further comprise an IF amplifier 206, as shown in FIG. 2C, coupled between the mixer 205 and the low pass filter 207. The IF amplifier 206 amplifies the signal IF_A from the mixer 205. Noise of frequencies other than IF is filtered out by the low pass filter 207 such that an IF output signal IF_B is generated.

The invention utilizes a low frequency local oscillator to generate a signal with a half frequency of a required local oscillator frequency. The harmonic with the required local frequency is generated by a harmonic filter and transmitted to a mixer for further process such that frequency downconverting is achieved.

While the invention has been described by way of examples and in few embodiments, it is to be understood that the invention is not limited thereto. To the contrary, it is intended to cover various modifications and would be apparent to those skilled in the art. Therefore, the scope of the appended claims should be accorded the broadest interpretation so as to encompass all such modifications.

What is claimed is:

1. A low noise downconverter, comprising:
a low noise amplifier receiving an RF input signal;
an RF band pass filter coupled to the low noise amplifier;
a mixer coupled to the RF band pass filter;
a local oscillator providing a signal of half local oscillator frequency of required by mixer;
a harmonic filter, coupled to the local oscillator, filtering out harmonic frequencies other than required local oscillator frequency and transmitting a filtered signal to the mixer; and
a low pass filter, coupled to the mixer, providing an IF output signal.

2. The low noise downconverter of claim 1, further comprising a driver amplifier, coupled between the harmonic filter and the mixer, and a band pass filter coupled between the driver amplifier and the mixer.

3. The low noise downconverter of claim 1, further comprising an IF amplifier coupled between the mixer and the low pass filter.

4. The low noise downconverter of claim 1, wherein the local oscillator is a dielectric resonant oscillator.
